(19) United States
(12) Patent Application Publication
(10) Pub. No.: US 2024/0407334 A1
(43) Pub. Date: Dec. 12, 2024

(54) FOOT SYSTEM FOR ANIMALS

(71) Applicant: Kristy Dole, Modesto, CA (US)

(72) Inventor: Kristy Dole, Modesto, CA (US)

(21) Appl. No.: 18/736,339

(22) Filed: Jun. 6, 2024

Related U.S. Application Data
(60) Provisional application No. 63/507,055, filed on Jun. 8, 2023.

(51) Int. Cl. A01K 13/00

(52) U.S. Cl. CPC A01K 13/007

(57) ABSTRACT

A footwear system for an animal includes: a shell including a front surface and a back surface, each including a loop portion, and the shell having a top portion and a bottom portion, the top portion having a width smaller than a width of the bottom portion, and a strap having a hook side including hooks, the hook side of the strap to be connected to the loop portions of the front and back surfaces of the shell, wherein the front surface and the back surface include the same material.

### CROSS-REFERENCE TO RELATED APPLICATIONS

The present application claims the benefit of U.S. Provisional Application Ser. No. 63/507,055, filed on Jun. 8, 2023, the entire content of which is hereby incorporated by reference.

### BACKGROUND

Pets and other domesticated animals can injure their paws while walking, running, etc. during daily activities. Whether in urban environments where animals are more likely to encounter manmade objects, or in more rural or natural environments, foot hazards can cause injuries that range from minor to serious for pets and other animals.

Footwear for animals can serve both as a preventative measure, to avoid injuries, and as an aid for treatment and recovery, by protecting paws after an injury has already occurred.

However, existing footwear for animals is limited and many only provide a poor fit and/or less than adequate functionality. Animal paw/ankle movement is more like the hand/wrist; however, unless the footwear is incredibly fitted to the paw (which may be uncomfortable for the animal), or has an adequate anchor point (such as a thumb is to a mitten, which may be difficult to maintain aligned on the animal's foot/paw), footwear tends to twist or flip over. Thus, footwear options tend to rotate during use, with the sole of the shoe rotating to the top of the paw and the soft top of the shoe rotating to the bottom of the paw, resulting in little or poor protection for the animal's paw during use.

Further, available animal footwear appears to be limited in size, not providing options for very large or very small animals. Even brands that may offer size options can be problematic, because it can be difficult to determine the correct size for a particular animal, as a result of structural variations between the paws of different animals, breeds, and/or the requirements of a particular animal, for example. Further, footwear that may fit the back paws may not fit the front ones in animals, like dogs, where the front paws are larger.

The above information disclosed in this Background section is only for enhancement of understanding of the background of the disclosure and therefore it may contain information that does not constitute prior art.

### SUMMARY

Aspects of embodiments of the present disclosure provide a footwear system that is adjustable to allow for various size paws to be accommodated. Hereinafter, “paw” generally refers to the foot of any animal, including animals that have pads and/or claws, hooves, etc.

Aspects of embodiments of the present disclosure provide a footwear system that is double-sided to provide protection to the animal's paws even when the footwear is rotated during use.

Aspects of embodiments of the present disclosure provide a footwear system that is comfortable and able to fit a variety of animal sizes and/or shapes.

Aspects of embodiments of the present disclosure provide a footwear system that accounts to natural paw movement, allowing toes to bend and spread naturally over surfaces, for example, even as the footwear safely and comfortably rotates.

Additional aspects will be set forth in part in the description which follows and, in part, will be apparent from the description, or may be learned by practice of the presented embodiments of the disclosure.

One or more embodiments of the present disclosure provide a footwear system for an animal including a shell including a front surface and a back surface, each including a loop portion, and the shell having a top portion and a bottom portion, the top portion having a width smaller than a width of the bottom portion, and a strap having a loop side including loops and a hook side including hooks, the hook side of the strap to be connected to the loop portions of the front and back surfaces of the shell, wherein the front surface and the back surface include the same material.

One or more embodiments of the present disclosure provide a footwear system for an animal including a shell including a front surface and a back surface, each including a loop portion, and the shell having a top portion and a bottom portion, the top portion having an intermediate waist smaller than the width of the bottom portion, a sock to insert into the shell, and a strap having a loop side including loops and a hook side including hooks, the hook side of the strap to be connected to the loop portions of the front and back surfaces of the shell.

### BRIEF DESCRIPTION OF THE DRAWINGS

FIG. 1 is a front elevational view of a footwear system according to one or more embodiments of the present disclosure.

FIG. 2 is a perspective view of the footwear system according to one or more embodiments of the present disclosure.

FIG. 3 is a side view of the footwear system in use on an animal, according to one or more embodiments of the present disclosure.

FIG. 4 is a perspective view of a shell for a footwear system, according to one or more embodiments of the present disclosure.

FIG. 5 is a perspective view of a shell for a footwear system, according to one or more embodiments of the present disclosure.

FIG. 6 is a side view of a footwear system including an elongated tall sock in use on an animal, according to one or more embodiments of the present disclosure.

FIG. 7 is a perspective view of the tall sock, according to one or more embodiments of the present disclosure.

FIG. 8 is a perspective view of a tie up sock in use on an animal, according to one or more embodiments of the present disclosure.

FIG. 9 is a perspective view of a strap of a footwear system including removable bumpers, according to one or more embodiments of the present disclosure.

FIG. 10 is an exploded view of a removable bumper, according to one or more embodiments of the present disclosure.

FIG. 11 is a perspective view of a footwear system including additional loops, according to one or more embodiments of the present disclosure.

FIG. 12 is a perspective view of a shoe and strap of the footwear system of FIG. 11, according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

A footwear system for an animal may be double-sided, e.g., including a protective material on both sides (e.g., front and back), to allow for protection of the animal's paws while in use, even if the footwear (shell and/or sock) rotates. The footwear system may also include a strap that may be positioned to reduce or increase the size of the footwear in order to accommodate a variety of paw sizes and shapes. The shape and size of the toe area of the footwear may provide sufficient space for the animal's paws as they naturally spread while standing, walking, running, etc.

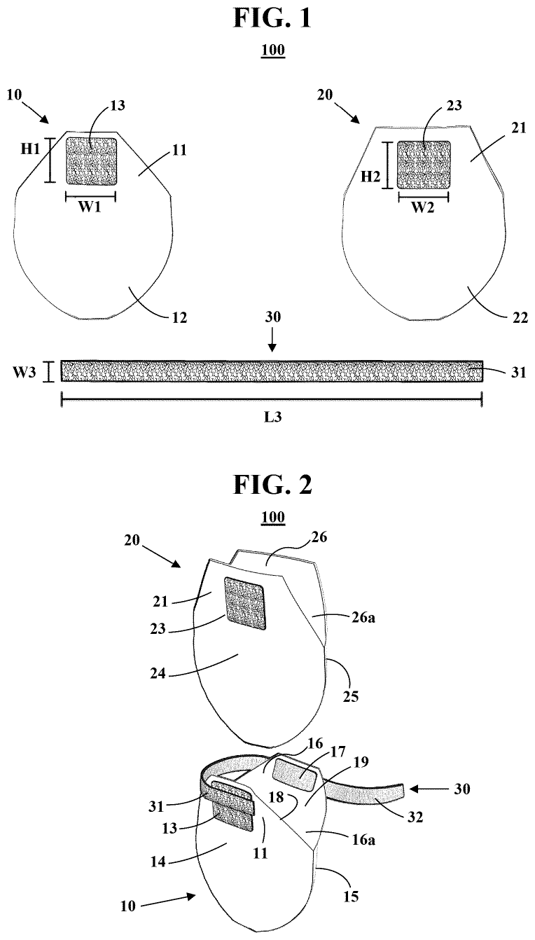

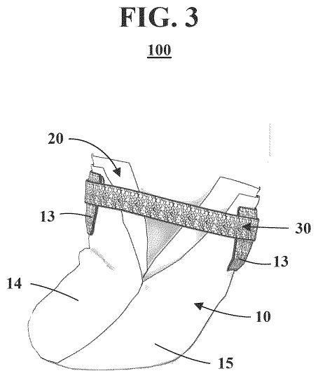

FIG. 1 is a front elevational view of a footwear system 100 including a shell (e.g., shoe) 10, a sock 20 and a strap 30, according to one or more embodiments of the present disclosure. In one or more embodiments, the footwear system is reversible (e.g., the front and the back surfaces of the footwear system may be substantially identical and symmetrical), and a rear view of the footwear system may be the same as the front view shown in FIG. 1. FIG. 2 is a perspective view of the footwear system including the shell (e.g., shoe) 10, the sock 20 and the strap 30, according to one or more embodiments of the present disclosure. FIG. 3 is a side view of the footwear system 100 in use on an animal, with the strap 30 releasably connected to the shell 10, and with the sock 20 inside the shell 10.

### The Shell (Shoe)

The shell 10 can function as a sole for a shoe, with both the front and back of the shell being made of the same material so that even if the shoe shell 10 and/or sock 20 rotates while the animal is walking, the bottom of the paw will still be protected and the animal will still have coverage and/or grip while walking.

The shell 10 includes a top portion 11, a bottom portion 12, and a front surface 14 and back surface 15. In one or more embodiments, the shell 10 is reversible (e.g., the front and the back surfaces of the footwear system may be substantially identical) and/or it may be symmetrical, and a back surface 15 of the shell 10 may be the same as the front surface 14.

The top portion 11 of the shell 10 may be generally trapezoidal in shape and designed to fit over the ankle of an animal, such as a domesticated dog, cat, and/or the like. The shape is not limited to trapezoidal, and may be any shape that will allow coverage of the animal's ankle, such as rectangular, curved (e.g., semi-circular or semi-oval shaped), etc. The shape (e.g., the trapezoidal or curved shape) of the top portion 11 may help prevent bunching by either or both of the shell 10 and/or the sock 20. For example, due to an animal's ankle typically being narrower in circumference than its paw, the smaller and/or narrower width at the top portion 11 of the shell 10, which will rest near the animal's ankle when in use, may help reduce or eliminate extra material bunching at the ankle when the strap 30 is fitted into place.

The bottom portion 12 may be curved, for example, generally semi-circular in shape to house the paw of the animal. The shape is not limited to semi-circular, and may be any shape that will allow coverage of the animal's paw, such as rectangular, curved (e.g., semi-circular, semi-oval shaped), etc. The bottom portion 12 is shaped to be spacious (e.g., have a spacious volume) to accommodate the paws of the animal while standing, walking, running, etc., as the paw will naturally expand during these activities.

The top portion 11 may have a smaller width than the bottom portion 12 so that the top portion can be strapped closed using the strap 30. As the ankle of the animal is typically smaller than the paw, and the smaller width will allow the top portion of the shell 10 to be strapped to the ankle with no overlap or less overlap at the sides of the shell 10 than would occur in a shell with vertical sides. As shown, for example, in FIG. 2, the top portion 11 may be open at one or both sides (e.g., may have side openings 16a at the top portion 11) so that the smaller width does not limit the animal from being able to have its paw inserted into the shell 10 and to prevent or reduce any material of the shell 10 from bunching at the sides, which may be potentially uncomfortable for the animal.

The shell 10 has a front and a back including a front exterior surface 14 and a back exterior surface 15, respectively. The front and back of the shell 10 may be made of the same material, and/or may both be made of a material that can be used as the sole of the shell 10, so that if the shell rotates while the animal is walking, the sole material will always be on the bottom. The front and back may be integral (e.g., one piece of fabric), or may be sewn together. In one or more embodiments, the shell 10 may include a reinforced toe portion, either on the interior or exterior of the shell 10.

Various materials and/or fabrics may be used for the shell 10. For example, a material with grip or tread may be used, or for warmer areas, a breathable or material with porosity may be used. Materials for the shell 10 may include durable flexible fabrics and/or materials such as leather, natural rubber, synthetic rubber, and/or a rubberized material, silicone, and/or PVC (e.g., non-woven materials), or heavy fabrics (e.g., woven fabrics) such as canvas and/or nylon. The material can be solid, vented, may have a mesh or net construction, etc., and/or may be coated/dipped to provide grip and/or traction. For example, the material may be a mesh or perforated in order to provide more airflow and/or to be used as water shoes. Such shoes may be worn directly on the animal's paws, without an internal sock, for example. The material of the shell 10 may protect the animal's paw from rough surfaces, hot and/or cold temperatures, elements such as rain and/or snow (e.g., the shell may be water resistant and/or waterproof); and/or may be a material serving one or more medical purpose (e.g., materials for protecting foot wounds, such as casts, hypoallergenic materials for animals with allergies, and/or materials to guard against pathogens, pollutants, allergens, chemicals, dirt, salt, burrs, etc.).

In some embodiments, the shell 10 may include a single layer or multiple layers. For example, an interior breathable moisture wicking layer and exterior water resistant/proof layer may be included. In one or more embodiments, the front surface 14 and the back surface 15 may each be flat pieces of material and/or fabric that are sewn together at the edges along the sides.

The shell 10 may have a top opening 16 at the top portion 11. The opening 16 is where the animal's paw can be inserted. The opening 16 may be large enough to allow for the animal's paw to be inserted. The opening 16 may be at the top of the shell 10 in the direction from the top portion 11 to the bottom portion 12 of the shell 10. The shape of the bottom portion 12 may be semi-circular at the bottom with substantially straight sides extending from the semi-circular bottom so that the size of the opening 16 is sufficient to facilitate insertion of the paw. In one or more embodiments, the shape of the bottom portion 12 may be semi-circular without substantially straight sides. The bottom portion 12 of the shell 10 may not taper or decrease towards the top portion 11 so that the widest part of the animal's paw may be easily inserted.

In some embodiments, as shown in FIG. 2, the sides of the top portion 11 may be open (e.g., not sewn together or closed). This may increase the size of the opening 16 helping to further facilitate the insertion of the animal's paw. For example, in one or more embodiments, the top portion 11 may be substantially trapezoidal in shape, and side openings 16a may be defined by the lateral, angled sides of the trapezoid. The side openings 16a are continuous with the opening 16 forming a flap at the top of the shell 10 which may be flexed outwardly to provide a sufficiently large opening for the animal to insert its paw. The space between the front surface 14 and back surface 15 due to the side openings 16a may be closed or substantially closed when the strap 30 is used to close the shell 10. The side openings 16a will decrease in size or be substantially eliminated when the strap 30 closes the shell 10, but due to the side openings 16a, there is little or no overlapping of the shell 10 at the sides of the shell 10 at the top portion 11, thus preventing bunching of fabric/material at the sides of the shell 10, which may be uncomfortable for the animal. In embodiments in which the shape is not trapezoidal, but is semi-circular, semi-ovular, etc., the lateral sides may similarly define side openings to avoid bunching. In addition, the side openings may provide an additional pathway through which air and/or heat may escape to help the animal's paws stay cooler and/or dryer.

The shell 10 may include a loop catch portion 13 on the front surface 14 and/or the back surface 15 that includes loops as part of a hook and loop attachment system. The loop portions 13 may releasably connect to hooks 32 on the strap 30. The loop portion 13 on the front surface 14 may be the same as the loop portion 13 on the back surface 15 and in the same relative position on the surface; however, the present disclosure is not limited thereto.

The loop portions 13 may be taller (for example, in the direction from the top portion 11 to the bottom portion 12 of the shell 10) than the strap 30 is wide. For example, the loop portions 13 may have a height H1 greater than the width W3 of the strap 30. In some embodiments, the loop portions 13 may have a height H1 approximately 1.5 times the strap's width W3, or may have a height H1 approximately twice or three times the strap's width W3. For example, the shell 10 may have loop portions 13 each having a height H1 of about 0.5″ to about 3″ and the strap 30 may have a width W3 of about 0.25″ to about 1″. In some embodiments, the shell 10 may have loop portions 13 each having a height H1 of about 0.75″ to about 1.5″ and the strap 30 may have a width W3 of about 0.375″ to about 0.75″. In some embodiments, designed for animals having smaller paws, the height H1 may be equal to or more than about 0.75″ and the width W3 may be equal to or more than about 0.375″, and for embodiments for larger animals, the height H1 may be equal to or less than about 1.5″ and the width W3 may be equal to or more than about 0.75″. In one or more embodiments, the height H1 may be about 0.75″, 1″, or 1.5″ and the width W3 may be about 0.375″, 0.5″ or about 0.75″, respectively. However, these heights and widths are just examples, and the present disclosure is not limited thereto.

Having the height H1 larger than the width W3 allows the strap 30 to be releasably placed at various vertical heights closer or farther from the bottom portion 12 of the shell 10 depending on the size and shape of the animal's paw and Keratin length (e.g., length of the nail, claw or hoof), thus making the shell 10 adjustable. This is useful for providing a better fit for a wider range of animals, and also provides a fit for the front and back feet of an individual animal (as front feet may be larger in some species, like dogs).

The width W1 of each the loop portion 13 may be sufficiently wide to securely attach to the strap 30 and stay attached to the strap 30 during use (e.g., while the animal wearing the footwear system is standing, walking, running, etc.). For example, the shell 10 may have loop portions 13 each having a width W1 of about 0.5″ to about 3″. For example, the shell 10 may have loop portions 13 each having a width W1 of about 0.75″ to about 1.5″. In some embodiments, designed for animals having smaller paws, the width W1 may be equal to or more than about 0.75″ and for embodiments for larger animals, the width W1 may be equal to or less than about 1.5.″ In one or more embodiments, the width W1 may be about 0.75″, 1″, or 1.5″ and the width W1 may be the same as the height H1.

Each loop portion 13 may be generally square or rectangular (or any other suitable shape) and a loop portion 13 may be included on the top portion 11 of the front surface 14 and the top portion 11 of the back surface 15. In some embodiments, the loop portions 13 may have rounded corners (e.g., a rectangle or square with rounded corners) to help form better to the animal's leg and/or to avoid sharp corners. Including a loop portion 13 on each of the front and back surfaces 14, 15 may help hold the strap 30 securely in place and reduce displacement of the strap 30 (e.g., may prevent or substantially prevent the strap 30 from riding up on the side without a loop portion during use, and may prevent or reduce the likelihood of the shell 10 from slipping out from under the strap 30 and the shell 10 falling off during use). Including one loop portion on each of the front and back surfaces 14, 15 may be sufficient to secure the shell 10 from displacement and from falling off.

The shell 10 may also include hook portions 17 on one or both of the inner surfaces 18, 19 of the shell 10. The inner surface 18 may be opposite the front exterior surface 14 (e.g., on the opposite surface of the front side of the shell 10 relative to the front surface 14) and the inner surface 19 may be opposite the back exterior surface 15 (e.g., on the opposite surface of the back side of the shell 10 relative to the back surface 15). In embodiments in which there are hook portions on both the inner surface 18 and the inner surface 19, the hook portions 17 may be opposite each other and face each other. The hook portions 17 may connect to loop portions 23 of the sock 20 when the shell 10 is worn with the sock 20. The hook portions 17 may be shorter in height than the loop portions 23 of the sock 20 allowing vertical adjustment and connection of the shell 10 to the sock 20. For example, the hook portions 17 may have a height substantially the same as the width W3 of the strap 30. For example, the hook portions 17 may have a height that is half the height H1 of the loop portions 13 and/or half the height H2 of the loop portions 23 of the sock 20, discussed in more detail below. The widths and lengths of the hook portions 17 are sufficiently wide and long to releasably attach to the sock 20 and stay attached to the sock 20 during use (e.g., when the animal wearing the footwear system is walking, running, etc.).

Each hook portion 17 may be generally square or rectangular (or any other suitable shape) and the hook portions 17 may be included in the top portion 11 of the shell 10. In some embodiments, the hook portions 17 may have rounded corners (e.g., a rectangle or square with rounded corners) to help form better to the animal's leg and avoid sharp corners.

In some embodiments, the inner surfaces 18, 19 of the shell 10 may include loop portions instead of or in addition to the hook portions 17, and a double-sided hook strip (e.g., a detachable hook strip) may be used to attach or connect the inner surfaces 18, 19 of the shell 10 to the sock 20 having loop portions 23. In embodiments having a shell 10 with internal loop portions instead of internal hook portions 17, the shell 10 may be worn without a sock 20 and may avoid potential irritation caused by hook portions rubbing against the animal's paw and/or ankle. In some embodiments, the internal hook portions may not be provided.

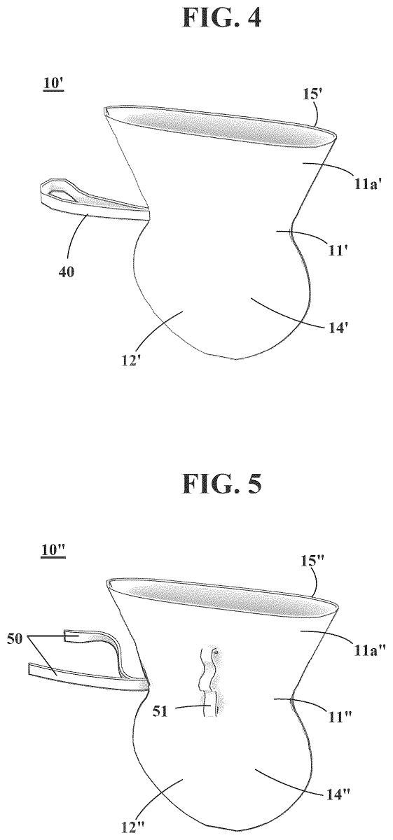

FIG. 4 is a shell 10′ for a footwear system according to one or more embodiments of the present disclosure. FIG. 5 is a shell 10″ for a footwear system according to one or more embodiments of the present disclosure.

Shells 10′, 10″ may have front surfaces 14′, 14″ and back surfaces 15′, 15″ that are integral (e.g., one piece of fabric), or sewn together. For example, shell 10′ or shell 10″ may each be made of a single piece of waterproof or water resistant material in order to be fully enclosed and to provide protection to the animals' feet from water, such as rain or snow. The waterproof or water-resistant material may have a rough or bumpy texture to provide grip for use on slippery surfaces.

Top portions 11′, 11″ of the shells 10′, 10″ may have a smaller width (e.g., an intermediate waist smaller) than bottom portions 12′, 12″, respectively, so that the top portions 11′, 11″ can be strapped closed and to support the ankle of the animal, which is typically narrower in circumference. The shells 10′, 10″ may further include an elongated top portions 11a′, 11a″ extending from the top of the top portions 11′, 11″ in a direction from the bottom portions 12′, 12″ to the top portions 11′, 11″. This increased height of the shell 10′, 10″ may help prevent water or debris from entering the shell. In some embodiments, the top (i.e., from the smallest width of the waist up to the top of the elongated top portions 11a′, 11a″) may be substantially the same height as the bottom portions 12′, 12″ (from the waist down to the bottom of the bottom portions 12′, 12″), respectively. In some embodiments, the top of the shell 10′, 10″ may be slightly taller than a top portion 21 of the sock 20, respectively. For example, the top may be about 0.5″ to about 1″ taller than the height of the top portion 21 of the sock 20.

Either shell 10′ or shell 10″ may be used as an alternative to the shell 10, or may be used on top of shell 10 to provide additional protection, for example, protection from rain or snow.

As shown in FIG. 4, the shell 10′ may include an elastic loop closure 40 attached to the shell 10′. However, the present disclosure is not limited thereto, and the elastic loop closure may be a separate or unattached piece. The elastic loop closure 40 can be stretched to wrap around the animal's ankle while the animal is wearing the shell 10′ to hold the shell 10′ on the animal's paw. For example, the shell 10′ may be placed on the animal's paw, and when the top portion 10′ is substantially around or surrounding the animal's ankle, the loop closure 40 may be stretched to pass over the animal's paw in the shell 10′ and positioned around the animal's ankle in the top portion 11′.

As shown in FIG. 5, the shell 10″ may include (alternative to or in addition to the elastic loop closure 40 of FIG. 4) ties 50 and loops 51. FIG. 5 shows three loops; however, the present disclosure is not limited thereto and 1, 2, 3, 4 or more loops may be included. To secure the shell 10″ to the animal's paw and ankle, the ties 50 may be threaded through one of the loops 51 and tied. Any of the loops 51 may be used to secure the shell 10″ to the animal's paw, and a particular loop 51 may be selected based on the shape and/or size of the animal's paw and/or ankle to help secure the shell 10″ at the animal's ankle. Thus, the inclusion of multiple loops 51 allows the shell 10″ to be adjustable based on the physical characteristics of the animal's paw and/or ankle. The loops 51 may be included on only one surface (e.g., the front surface 14″) or both surfaces (e.g., the front and back surfaces 14″, 15″) of the shell 10″. In some embodiments, the loops 51 may be included on a side surface of the shell 10″ opposite the side surface at which the ties 50 are located.

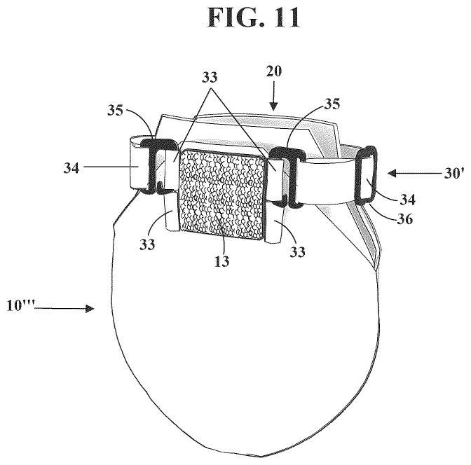

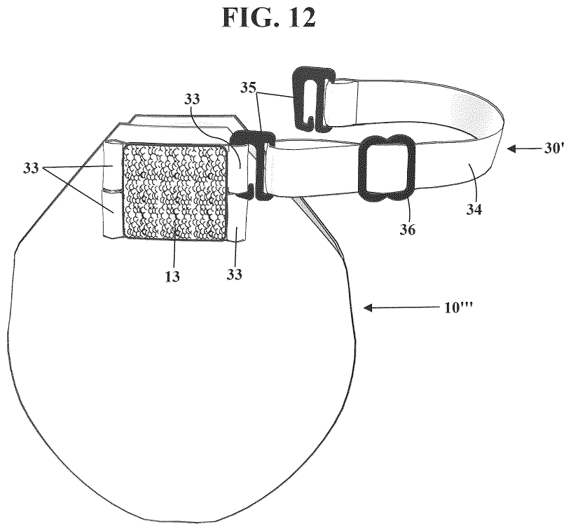

In one or more embodiments, the closures 40, 50 as shown in FIGS. 4 and 5 may be used with the shell 10 (see, e.g., FIGS. 1-3) instead of or in addition to the loop portions 13 and strap 30 to secure the shell to the animal's paw/ankle. In one or more embodiments, instead of the closures 40, 50, the shell 10′ and/or 10″ may include the loop portions 13 at the intermediate waist of the top portion 11′ and/or 11″, respectively, and may be used with the strap 30, as described above with reference to FIGS. 1-3. In one or more embodiments, instead of or in addition to the loop portions 13, the elastic loop closure 40, or the ties 50 and loops 51, as shown in FIGS. 1-5, holes, ribbons, buttons, snaps, magnets, laces, elastic and/or the like may be used to secure the shell to the animal's paw or ankle. For example, the loops 33, as shown in FIGS. 11 and 12, may be used, as described in more detail below. In one or more embodiments, the shell 10 (or shells 10′, 10″) may be worn directly on the animal's paws, or may be worn over one or more socks (described in more detail below) or other shells.

### The Sock

As shown, for example, in FIGS. 1 and 2, the footwear system 100 may also include the sock 20 that can fit inside any of the shells 10, 10′, 10″ (hereinafter referred to as shell 10 for ease of explanation). The sock 20 may also include the same material on the front and back sides so that it can rotate while in use. For example, the sock 20 may be reversible and the sock 20 may have right/left symmetry, like similar to embodiments of the shell 10 described above. The sock 20 may be used alone or may be used within the shell 10.

The sock 20 may be a softer material than the shell 10 for comfort purposes and may serve to protect the animal's paw and/or to prevent the shell 10 from rubbing the animal's paw. The sock may be a similar shape and size as the shell 10. In some embodiments, the sock 20 may be slightly smaller than the shell 10 so that it may be easily inserted into the shell 10. In some embodiments, the sock 20 may be taller than the shell 10 to provide additional warmth and/or protection to the animal's ankle and/or leg.

As shown, for example, in FIGS. 1 and 2, the sock 20 includes a top portion 21, a bottom portion 22, and a front and back side including front surface 24 and back surface 25, respectively. The top portion 21 of the sock 20 may be generally trapezoidal in shape and designed to fit over the ankle of an animal. However, the shape is not limited to trapezoidal, and may be any shape that will allow coverage of the animal's ankle, such as rectangular, curved (e.g., semi-circular or semi-oval shaped), etc. The top portion 21 of the sock 20 may be wider than the top portion 12 of the shell 10 so that the soft material of the sock 20 may contact the animal's ankle and prevent the shell 10 from rubbing the animal's leg. The shape (e.g., the trapezoidal or curved shape) of the top portion 21 may help prevent bunching by either or both of the sock 20 and/or the shell 10. For example, due to an animal's ankle typically being narrower in circumference than its paw, the smaller and/or narrower width at the top portion 21 of the sock 20, which will rest near the animal's ankle when in use, may help reduce or eliminate extra material bunching at the ankle when the strap 30 is fitted into place.

The bottom portion 22 is curved and may be generally semi-circular in shape to house the paw of the animal. However, the shape is not limited to semi-circular, and may be any shape that will allow coverage of the animal's paw, such as rectangular, curved (e.g., semi-circular, semi-oval shaped), etc. The bottom portion 22 is shaped to be spacious (e.g., have a spacious volume) to accommodate the paws of the animal while standing, walking, running, etc., as the paw will naturally expand during these activities.

The top portion 21 may have a smaller width than the bottom portion 22 so that the top portion 21 can be strapped closed using the strap 30. As the ankle of the animal is typically smaller than the paw, the smaller width will allow the top portion 21 of the sock 20 to be strapped to the ankle with no overlap or a small amount of overlap at the sides of the sock 20. As shown, for example, in FIG. 2, the top portion 21 may be open at one or both sides (e.g., may have side openings 26a at the top portion 21) so that the smaller width does not limit the animal from being able to have its paw inserted into the sock 20 and to prevent or reduce any material of the sock 20 from bunching at the sides, which may potentially be uncomfortable for the animal.

The sock 20 has a front surface 24 and back surface 25. The front and back surfaces 24, 25 (and, thus, front and back sides of the sock 20) may be made of the same material. The front and back surfaces 24, 25 may be integral (e.g., one piece of fabric), or may be sewn together. In one or more embodiments, the sock 20 is reversible, and a back surface 25 of the sock 20 may be the same as a front surface 24. In one or more embodiments, the sock 20 may include a reinforced toe portion, either on the interior or exterior of the sock 20.

The sock 20 may have a top opening 26 at the top portion 21. The opening 26 is where the animal's paw can be inserted. The opening 26 may be large enough to allow the animal's paw to be inserted. The opening 26 may be at the top of the sock 20 in the direction from the top portion 21 to the bottom portion 22 of the sock 20. The shape of the bottom portion 22 may be semi-circular at the bottom with substantially straight sides so that the size of the opening 26 is sufficient to facilitate insertion of the paw. In one or more embodiments, the shape of the bottom portion 22 may be semi-circular at the bottom without substantially straight sides. The bottom portion 22 of the sock 20 may not taper or decrease towards the top portion 21 so that the widest part of the animal's paw may be easily inserted.

In some embodiments, as shown in FIG. 2, one or both sides of the top portion 10 21 may be open (e.g., not sewn together or closed). These side openings 26a may increase the size of the opening 26 helping to further facilitate the insertion of the animal's paw. For example, in one or more embodiments, the top portion 21 may be substantially trapezoidal in shape, and side openings 26a may be defined by the lateral, angled sides of the trapezoid. The side openings 26a are continuous with the opening 26 forming a flap at the top portion 21 of the sock 20 which may be flexed outwardly to provide a sufficiently large opening for the animal to insert its paw. The space between the front surface 24 and back surface 25 due to the side openings 26a may be closed or substantially closed when the strap 30 is used to close the sock 20 (or the sock 20 and shell 10 together). The side openings 26a will decrease in size or be substantially eliminated when the strap 30 closes the sock 20, but due to the side openings 26a, there is little or no overlapping of the sock 20 at the sides of the sock 20 at the top portion 21, thus preventing bunching of fabric/material at the sides of the sock 20, which may be uncomfortable for the animal. In embodiments in which the shape is not trapezoidal, but is semi-circular, semi-ovular, etc., the lateral sides may similarly define side openings to avoid bunching. In addition, the side openings may provide an additional pathway through which air and/or heat may escape to help the animal's paws stay cooler and/or dryer. In some embodiments, the side openings 26a may not be included and the sock 20 may be made from a stretchy material and have straight sides or may have an intermediate waist smaller than the bottom portions 22.

The sock 20 may include a loop portion 23 on the front surface 24 and/or on the back surface 25 that includes loops as part of a hook and loop attachment system. The loop portions 23 may releasably connect to the hook portions 17 on the interior of the shell 10. In some embodiments, the loop portions 23 may also releasably connect to hooks 32 on the strap 30. In one or more embodiments, the loop portions 23 may releasably connect to a double-sided hook strip (e.g., a detachable hook strip) that may be used to attach or connect the inner surfaces 18, 19 of the shell 10 to the loop portions 23 of the sock 20 when the shell 10 has inner surfaces 18, 19 including loop portions, as described above.

The loop portions 23 may be taller (for example, in the direction from the top portion 21 to the bottom portion 22 of the sock 20) than the strap 30 is wide. For example, the loop portions 23 may have a height H2 greater than the width W3 of the strap 30. In some embodiments, the loop portions 23 may have a height H2 approximately 1.5 times the strap's width W3, or may have a height H2 approximately twice or three times the strap's width W3. For example, the sock 20 may have loop portions 23 each having a height H2 of about 0.5″ to about 3″ and the strap 30 may have a width W3 of about 0.25″ to about 1″. In some embodiments, the sock 20 may have loop portions 23 each having a height H2 of about 0.75″ to about 1.5″ and the strap 30 may have a width W3 of about 0.375″ to about 0.75″. In some embodiments, designed for animals having smaller paws, the height H2 may be equal to or more than about 0.75″ and the width W3 may be equal to or more than about 0.375″, and for embodiments for larger animals, the height H2 may be equal to or less than about 1.5″ and the width W3 may be equal to or more than about 0.75″. In one or more embodiments, the height H2 may be about 0.75″, 1″, or 1.5″ and the width W3 may be about 0.375″, 0.5″ or about 0.75″, respectively. However, these heights and widths are just examples, and the present disclosure is not limited thereto.

Having the height H2 larger than the width W3 allows the strap 30 to be releasably placed at various vertical heights closer or farther from the bottom portion 22 of the sock 20 depending on the size and shape of the animal's paw and Keratin length (e.g., length of the nail, claw or hoof), thus making the sock 20 adjustable. This is useful for providing a better fit for a wider range of animals, and also provides a fit for the front and back feet of an individual animal (as front feet may be larger in some species, like dogs).

In some embodiments, the height H2 of the loop portions 23 may be greater than, for example, twice, a height of the hook portions 17 on the interior of the shell 10. In addition, the loop portion may have a width W2 substantially equal to a width of the hook portions 17 on the interior of the shell 10. The hook portions 17 may be shorter in height than the loop portions 23 of the sock 20 allowing vertical adjustment and connection of the shell 10 to the sock 20.

In one or more embodiments, the loop portions 23 may have a height H2 greater than the width W3 of the strap 30. This allows the strap 30 to be releasably placed at various vertical heights closer or farther from the bottom portion 22 of the sock 20 depending on the size and shape of the animal's paw and Keratin length (nail/claw/hoof), thus making the sock 20 adjustable when directly attached to the strap 30 (i.e., when the sock 20 is used without the shell 10). This is useful for providing a better fit for a wider range of animals, and also to provide a fit for the front and back feet of an individual animal (as front feet may be larger in some species like dogs).

The width W2 of each loop portion 23 may be sufficiently wide to securely attach to the shell 10 or to the strap 30, and to stay attached to the shell 10 or strap 30, respectively, during use (e.g., while the animal wearing the footwear system is walking, running, etc.). For example, the loop portions 23 may each have a width W2 of about 0.5″ to about 3″. For example, the sock 20 may have loop portions 23 each having a width W2 of about 0.75″ to about 1.5″. In some embodiments, designed for animals having smaller paws, the width W2 may be equal to or more than about 0.75″ and for embodiments for larger animals, the width W2 may be equal to or less than about 1.5.″ In one or more embodiments, the width W2 may be about 0.75″, 1″, or 1.5″ and the width W2 may be the same as the height H2.

Each loop portion 23 may be generally square or rectangular (or other suitable shape) and a loop portion 23 may be included on the top portion 21 of the front surface 24 and the top portion 21 of the back surface 25. In some embodiments, the loop portions 23 may have rounded corners (e.g., a rectangle or square with rounded corners) to help form better to the animal's leg and/or to avoid sharp corners. Including a loop portion 23 on each of the front and back surfaces 24, 25 may help hold the strap 30 securely in place and reduce displacement of the strap 30 (e.g., may prevent or substantially prevent the strap 30 from riding up on the side without a loop portion during use, and may prevent or reduce the likelihood of the sock 20 from slipping out from under the strap 30 and the sock 20 falling off during use). Including one loop portion on each of the front and back surfaces 24, 25 may be sufficient to secure the sock 20 from displacement and from falling off.

Because the sock 20 includes loop portions 23, but does not include any hook portions, the sock 20 can be washed without degradation of any hook portions, as hook portions tend to pick up threads and other textile debris during washing. This can help increase the longevity of the footwear system 100.

Various materials and/or fabrics may be used for the sock 20. For example, fleece or similar soft fabrics may be used, or moisture wicking fabrics may be used. Woven, non-woven and/or knitted fabrics may be used. The sock may include padding and/or cushioning (such as foam, etc.) for additional comfort or support. The sock 20 may include a single layer or multiple layers. In one or more embodiments, the sock 20 may include materials on the exterior that increase/enhance grip and/or traction.

For example, the sock 20 may be worn alone (e.g., without the shell 10) inside the animal's home (similar to a house sock or slipper) and attached with the strap 30. The sock 20 may have additional grip or traction enhancers on the front and back surfaces 24, 25 to reduce the chance of or to prevent slippage by the animal on interior floors of the house, which may include relatively slippery materials, such as wood flooring. Such grip and/or traction enhancers may include increased texture on the front and back surfaces 24, 25 that improve traction and/or rubber and/or other non-slip elements on the front and back surfaces 24, 25. For example, the grip or traction enhancers may include silicone, rubber, polyvinyl chloride (PVC), vinyl, latex, foam, nitrile, polyurethane, or any other suitable material that helps increase frictional force with ground or floor surfaces.

In one or more embodiments, the front surface 24 and the back surface 25 may each be flat pieces of material and/or fabric that are sewn together at the edges along the sides.

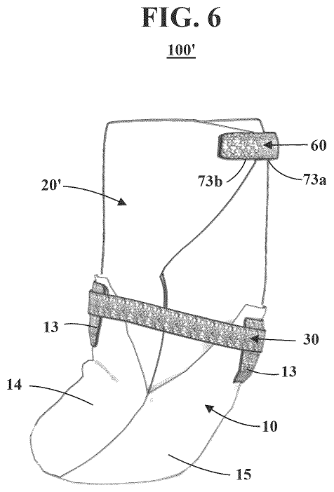

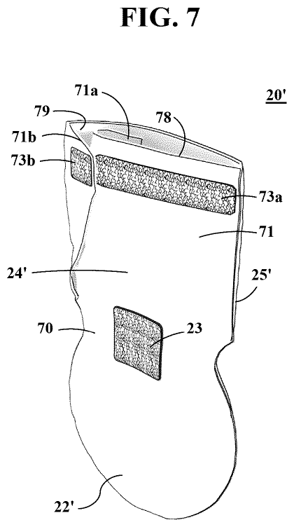

FIG. 6 is a side view of a footwear system 100′ including an elongated tall sock 20′ and shell 10, according to one or more embodiments. FIG. 7 is a perspective view of the tall sock 20′, according to one or more embodiments of the present disclosure.

In the illustrated embodiment of FIGS. 1-3, the sock 20 is generally/substantially the same length as the shell 10, or slightly longer. (For example, in use, the sock 20 may extend slightly higher than the shell 10 when the shell 10 is placed over the sock 20, even if the shell 10 and sock 20 are substantially the same height. This feature may prevent or limit the shell 10 from rubbing the animal's ankle and potentially irritating it). In FIG. 6, according to one or more embodiments, the tall sock 20′ is longer than the shell 10 and may, in use, cover a larger portion of the animal's leg.

The tall sock 20′ may have a height greater than a height of the shell 20. The tall sock 20′ may extend further up the animal's leg in use than the shell 10. For example, the tall sock 20′ may have a height twice that of the shell 20, or a ratio of the height of the shell 10 to the height of the tall sock 20′ above the shell 10 (when the tall sock 20′ is in the shell 10) may be about 50:50 or about 60:40, for example, about 50:50 to about 75:25, about 55:45 to about 70:30, or about 60:40 to about 70:30. In one or more embodiments, the height of the tall sock 20′ above the shell 10 (when the tall sock 20′ is in the shell 10) may be about 2″ and the total height of the tall sock 20′ may be 4.5″. For example, a ratio of the height of the tall sock 20′ above the shell 10 (when the tall sock 20′ is in the shell 10) to the total height of the tall sock 20′ may be about 50:50 or about 60:40, for example, about 50:50 to about 75:25, about 55:45 to about 70:30, or about 60:40 to about 70:30.

The tall sock 20′ may have a bottom portion 22′, a waist portion 70, and a top portion 71. The bottom portion 22′ may be substantially the same as the bottom portion 22 described above, for example, with reference to FIGS. 1-5, and thus a repeated description thereof may not be included here. The waist portion 70 may be narrower than the bottom portion 22′ and the top portion 71. The narrower waist portion 70 may help secure the animal's paw in the tall sock 20′ due to the taper in the shape of the waist portion 70, which will be approximately at the ankle of the animal when the tall sock 20′ is in use. The waist portion 70 may include loop portions 23 substantially the same as the loop portions 23 described above, for example, with reference to FIGS. 1-5, and thus a repeated description thereof may not be included here. The waist portion 70 may have a curved concave shape or an angular concave shape in a front and/or back view.

The top portion 71 of the tall sock 20′ may extend substantially straight from the waist portion 70 and/or may flare (e.g., may increase in width) as the top portion 71 extends in height from the bottom portion 22′. The top portion 71 may include a front surface 24′ and a back surface 25′, and may be open on one or both sides of the top portion 71 between the front surface 24′ and the back surface 25′. For example, FIG. 7 shows the tall sock 20′ open at one side and including a first edge 71a and a second edge 71b along the width direction of the tall sock 20′ in the top portion 71. In one or more embodiments, the opening on one or both sides of the top portion 71 may extend to the waist portion 70 to facilitate the insertion of the animal's paw.

The top portion 71 of the tall sock 20′ may also include a first loop portion 73a of a hook and loop attachment system that extends near to (and, e.g., spaced apart from) at least one edge (e.g., the first edge 71a) along a width direction of the top portion 71 on the front surface 24′, and may include a second loop portion 73b that extends to another edge (e.g., the second edge 71b) along the width direction of the tall sock 20′ from the back surface 25′. As shown in FIG. 7, the second loop portion 73b may wrap around from the back surface 25′ to the front surface 24′. In use, the first edge 71a of the front surface 24′ may extend behind the second edge 71b so that the first loop portion 73a and the second loop portion 71b are adjacent to each other. The second loop portion 73b may be directly at the second edge while the first loop portion 73a may be spaced apart or at a distance from the first edge 71a. However, the present disclosure is not limited thereto. In one or more embodiments, the second loop portion may be spaced apart or at a distance from the second edge while the first loop portion may be directly at the first edge. Also, both the first and second loops may be directly at the first and second edges or both may be spaced apart or at a distance from the edges.

The loop portions 73a, 73b of the tall sock 20′ may be releasably attached and/or connected together with a hook strip 60. The hook strip 60 may be sufficiently long to securely attach the front surface 24 and the back surface 25 of the sock together and stay attached during use (e.g., while the animal wearing the footwear system is walking, running, etc.). In some embodiments, two hook strips 60 may be used, one on each side of the sock 20, or only one side of the tall sock may be open so that only one hook strip 60 may be used to close and secure the sock.

While the hook strip 60 is shown in FIG. 6 to be a rectangular shape, the present disclosure is not limited thereto. The hook strip may be any shape as long as it includes sufficient hooks on at least one side of the hook strip to securely attach the front and back surfaces of the sock. For example, the hook strip may have hooks of a hook and loop attachment system on one side and a decorative shape on the other. In one or more embodiments, the hook strip may have the shape of a dog bone on one side with a hook strip on the back to attach the front and back surfaces together.

The first loop portion 73a may be longer than the second loop portion 73b. When the tall sock 20′ is worn by an animal having a narrower leg at the level of the loop portions 73a, 73b, the second loop portion 73b may overlap a portion of the first loop portion 73a near the first edge 71a, and the hook strip 60 may attach the second loop portion 73b to the exposed portion of the first loop portion 73a that is adjacent to the overlapping portion of the first loop portion 73a. This feature allows the sock to be adjustable and fit a variety of animals and breeds.

The hook strip 60 may be the same width as the first loop portion 73a and the second loop portion 73b. For example, the first loop portion 73a, the second loop portion 73b and the hook strip 60 may each have a width of about 0.25″ to about 1″, about 0.375″ to about 0.75″, or about 0.375″ to about 0.5″.

In one or more embodiments, the top portion 71 of the tall sock 20′ may include a third loop portion on the inner surface 78 (e.g., on the inside surface of the front surface 24′), and a fourth loop portion on an inner surface 79 at the second edge 71b (e.g., a surface on an inside of the tall sock 20′ at the second edge 71b). When the upper end of the top portion 71 is flipped to be on the outside, so that the third and fourth loop portions are on the outside of the tall sock 20′, the third loop portion and the fourth loop portion may be able to interact in a manner similar to the first loop portion 73a and the second loop portion 73b and may be connected together with the hook strip 60, and thus the description above regarding the first and second loop portions 73a, 73b may apply to the third and fourth loop portions as well, and repeated descriptions thereof may not be included. For example, the third and fourth loop portions may be used when the tall sock 20′ is shortened by folding over the upper end of the top portion 71, exposing the inside surfaces 78, 79. In one or more embodiments, the tall sock 20′ may include both the first and second loop portions as well as the third and fourth loop portions. In one or more embodiments, the tall sock 20′ may only include the first and second loop portions or only the third and fourth loop portions.

A range of materials/fabrics may be used for the tall sock 20′. For example, the tall sock 20′ may be made of any of the materials the sock 20 or shell 10 are made from, as described in more detail above. The tall sock 20′ may be made of the same material on all sides (e.g., the front and back sides) of the tall sock 20′.

The tall sock may be used to prevent the sock from collecting debris, such as sand, dirt, burrs, snow, etc., while the animal is wearing the sock. The tall sock may also protect the animal's leg from injury, for example, when the animal is moving in an area with tall grasses or other plants.

In one or more embodiments, the tall sock may not include the loop portions 73a, 73b. For example, the tall sock may include a front and back surface that are connected and closed together on both sides and the tall sock may extend vertically from the waist portion, either flaring wider or maintaining substantially the same width. These embodiments may include, for example, a tall sock 20′ made from a stretchy and/or elastic material. In one or more embodiments, the front and back sides may be substantially the same. The height of the tall sock may be shorter than shown in FIG. 7 in embodiments without the loop portions at the top portion, and the tall sock may stay upright based on the rigidity, material/fabric weight, elasticity, or other characteristics of the materials used to make the sock.

In some embodiments, the tall sock 20′ may be worn alone (e.g., without the shell 10) inside the animal's home (similar to a house sock or slipper) and attached with the strap 30. The tall sock 20′ may have additional grip or traction enhancers on its front and back surfaces to reduce the chance of or to prevent slippage by the animal on interior floors of the house, which may include relatively slippery materials, such as wood flooring. Such grip and/or traction enhancers may include increased texture that improve traction, and/or rubber and/or other non-slip elements on the front and back surfaces of the tall sock. For example, the grip or traction enhancers may include silicone, rubber, polyvinyl chloride (PVC), vinyl, latex, foam, nitrile, polyurethane, or any other suitable material that helps increase frictional force with ground or floor surfaces.

In one or more embodiments, the closures 40, 50 as shown in FIGS. 4 and 5 may be used with/on any of the socks 20, 20′, 20″ (see, e.g., FIGS. 1-3, and 6-8) instead of or in addition to the loop portions 23 and strap 30 to secure the shell to the animal's paw/ankle. In one or more embodiments, instead of or in addition to the loop portions 23, the elastic loop closure 40, or the ties 50 and loops 51, as shown in FIGS. 1-5, holes, ribbons, buttons, snaps, magnets, laces, elastic and/or the like may be used to secure the sock to the animal's paw or ankle. For example, the loops 33, as shown in FIGS. 11 and 12, may be used, as described in more detail below.

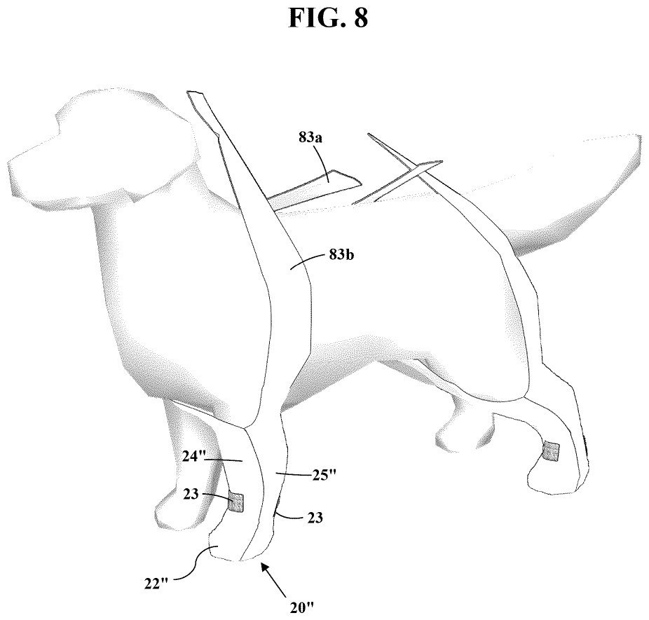

FIG. 8 is a perspective view of a tie up sock 20″ in use on an animal, according to one or more embodiments of the present disclosure.

The tie up sock 20″ may have a shape similar to the tall sock 20′ (and thus repetitious descriptions thereof may be omitted), though instead of at least one open side and the loop portions 73a, 73b at the top, the tie up sock 20″ may have sides that are attached and/or sewn together and tie ups 83a, 83b that wrap around the body of the animal to secure the sock 20″ to the animal.

The sock 20″ has a front side and a back side including a front exterior surface 24″ and back exterior surfaces 25″, respectively. The front and back sides of the sock 20″ may be made of the same material, so that if the sock 20″ rotates while the animal is walking, the same material will always be on the bottom. The front and back sides may be integral (e.g., one piece of fabric), or may be sewn closed together. The tie up sock 20″ may be made of an elastic material to stretch to the shape of the animal's leg, allowing the sock 20″ to be worn by a variety of animals and breeds. In some embodiments, the tie up sock 20″ may cover the entirety of the animal's leg, providing protection from environmental elements and/or hazards that may cause injury.

The tie ups 83a, 83b may be substantially long enough to wrap around the animal's body and be able to be securely tied together. The tie ups may include a first tie up 83a attached to and/or continuous with the front surface 24″ and a second tie up 83b attached to and/or continuous with the back surface 25″. Tie up socks 20″ may be used without strap 30, for example, when there is an injury in this area or if the animal does not like hook and loop closure systems.

The one or more embodiments, the tie up sock 20″ may have a waist portion including loop portions substantially the same as the loop portions 23 described above, for example, with reference to FIGS. 1-7, and thus a repeated description thereof may not be included here. In one or more embodiments, the tie up sock 20″ may not have a waist portion and may have substantially the same width along its entire height.

### The Detachable Strap

As shown, for example, in FIGS. 1-2, the strap 30 may have a long strip shape with one side having hooks (e.g., the hook side 32) of a hook and loop attachment system and the other side having loops (e.g., the loop side 31) and may include, for example, a Velcro® Brand One-Wrap. In one or more embodiments, the strap may have hooks 32 on one side and the other side may be flat with no loops.

The strap 30 may be made of a non-stretchy material so that the strap 30 won't stretch and allow the shell 10 and/or sock 20 to slide off the animal's paw while in use, and to help prevent or reduce the chance of the top portion of the sock 20 and/or shell 10 being too tightly attached at the animal's ankle, which could result in cutting off circulation when used for an extended amount of time. In some embodiments, the strap 30 may include pull tab on one end.

The width W3 of the strap 30 can vary. For example, in larger sized shells and socks made for larger animals, the strap may be wider to secure the shells/socks of the larger animal. In smaller sized shells and socks made for smaller animals, the strap may be thinner to fit the smaller frame and secure the shells/socks to the smaller animal. In some embodiments, the strap may be the same length and/or width throughout multiple sizes to reduce production costs.

As described above, the strap 30 may be narrower in width than the loop portions 13 of the shell 10 and/or the loop portions 23 of the sock 20 so that the strap 30 may be releasably placed at various vertical heights closer or farther from the bottom portion 12 of the shell 10 or the bottom portion 22 of the sock 20 depending on the size and shape of the animal's paw and Keratin length (e.g., length of the nail, claw or hoof), thus making the shell 10 and sock 20 adjustable. The vertical strap adjustment may also be useful to customize placement around dew claws, spurs, etc.

In some embodiments, the strap may be wider and may be able to be wrapped up the animal's leg, to aid in protecting the leg from hazards and/or the elements. In such embodiments, the strap may have elasticity to hold itself in place on the animal's leg and may attach to itself to secure itself on the leg.

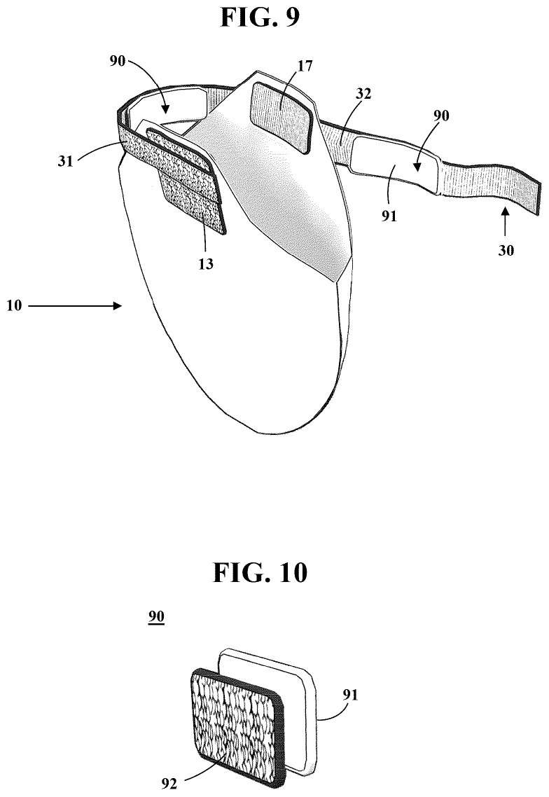

FIG. 9 is a perspective view of a strap 30 of a footwear system including bumpers 90, according to one or more embodiments of the present disclosure. FIG. 10 is an exploded view of a bumper 90, according to one or more embodiments of the present disclosure.

Bumpers 90 may be removably attachable to the hook side of the strap 30 to protect the animal's ankle and/or avoid rubbing of the hook side of strap 30 at the animal's ankle. For example, for animals having an ankle with a larger circumference, the shell 10 and/or sock 20 may not cover the sides of the animal's ankle when the shell 10 and/or sock 20 is secured to the animal's ankle. In the space between the sides of the shell 10 and/or the sock 20 (shown as a shell 10 in FIG. 9 for ease of description) a bumper 90 may be included to prevent or limit rubbing of the hook side 32 of the strap 30 against the animal's ankle. For example, the bumpers 90 may be included in the space created by the side openings 16a and/or side openings 26a.

Bumpers 90 may be made of a soft and/or foamy material on a front side 91 that may be comfortable for the animal and may be placed against the animal's ankle during use. Bumpers 90 may also have loops on a back side 92 to connect to the hook side 32 of the strap 30. The front and back sides 91, 92 may be two pieces sewn together or may be integral with each other. Bumpers 90 may be placed anywhere along the length of the strap 30. In one or more embodiments, the bumpers 90 may be placed to any other hook portions included in the footwear system, such as, for example, the hook portion 17 of the shell 10 when the shell 10 is worn without a sock 20.

### The System and Method

The sock 20, 20′, 20″ (hereinafter referred to as sock 20 for ease of explanation) can be inserted into the shell 10, 10′, 10″ (hereinafter referred to as shell 10 for ease of explanation) and worn together. The loop portions 23 of the sock 20 may attach to the hook portions 17 of the shell 10.

The sock 20 may either first be inserted into the shell 10 and then placed on the animal's paw, or the sock 20 may first be placed on the animal's paw and then the shell 10 placed around the sock 20. In the first case, the loop portions 23 of the sock 20 may be attached to the hook portions 17 of the shell 10 prior to insertion of the animal's paw. In the second case, the loop portions 23 of the sock 20 may be attached to the hook portions 17 of the shell 10 after insertion of the animal's paw. When both the sock 20 and the shell 10 are on the animal's paw, the strap 30 may be wrapped around the top portion 11 of the shell 10 (or alternative closures may be used, as shown, for example, in FIGS. 4-5 and FIGS. 11-12 below), and the hook side 32 of the strap 30 may be attached to the loop portions 13 on the front surface 14 and the back surface 15 of the shell 10. The excess strap 30 may continue to be wrapped around the top portion 11 of the shell 10 and the remaining hook side 32 of the strap 30 will attach to the loop side 31 of the strap 30. The strap 30 may be positioned along the height H1 of the loop portion 13 either closer to the top portion 11 or closer to the bottom portion 12 based on the size of the animal and the location of the animal's ankle.

In one or more embodiments, the sock 20 may be placed on the animal's paw and the strap 30 may be wrapped around the top portion 21 of the sock 20, with the hook side 32 of the strap 30 attaching to the loop portions 23 on the front surface 24 and the back surface 25 of the sock 20. The excess strap 30 may continue to be wrapped around the top portion 21 of the sock 20 and the remaining hook side 32 of the strap 30 will attach to the loop side 31 of the strap 30. In this case, the sock 20 may be worn with the strap 30 directly and without the shell 10 therebetween. In these embodiments, the shell 10 can then be placed over the sock 20 and the strap 30 and the hook portions 17 of the shell 10 can be attached to the loop side 31 of the strap 30. In some embodiments, a second strap can also be added around shell for extra securement (especially for animals who are highly active).

In some embodiments, the sock and strap can be worn, for example, inside a house or building and when the animal is leaving, the shell can be placed over the sock and strap. Further, if the animal is to enter a house or building, the shell and strap (if in use) can be easily removed and the sock and the strap directly on the sock can remain on the animal's paw.

The shell 10 and sock 20 may be stackable, e.g., more than one sock and/or shell may be used per paw. For example, in cooler environments, two socks may be used by inserting a first sock into a second sock, for additional warmth. The friction, caused by the material of the sock, for example a fleece, may help hold the first sock in position relative to the second sock. The footwear system may include optional detachable double sided hook strip to releasably attach onto the loop portion 23 of the sock and hook onto interior soft material of the second sock for enhanced bond. The socks may then also be inserted into a shell.

In some embodiments, for example in areas of rougher terrain or inclement weather, two shells may be utilized, with a first shell inserted and connected to the second shell (for example, an exterior waterproof or water-resistant shell), the loop portion of the internal shell connecting to the hook portion of the exterior shell. A sock may also be used inside the two shells.

In embodiments for smaller animals, smaller shells and socks may be used that have smaller and/or thinner hook and loop attachments and straps. In embodiments for larger animals, larger footwear with larger and/or wider hook and loop attachments and straps may be used.

The footwear system may be used for each of the animal's paws, or only one or more of the animal's paws. For example, only one paw may be used with the footwear system in cases where the animal has sustained an injury, and the footwear system is used to protect the injured paw/leg. In some embodiments, the footwear system may be used with all four of the animal's paws.

FIG. 11 is a perspective view of a footwear system including additional loops 33, according to one or more embodiments of the present disclosure. FIG. 12 is a perspective view of the shell 10′″ and strap 30′ of the footwear system of FIG. 11, according to one or more embodiments of the present disclosure.

As shown in FIGS. 11 and 12, the shell 10′″ may be substantially similar to the shell 10, but may also include loops 33 in addition to loop portions 13 on the front surface 14 and/or the back surface 15 of the shell 10′″. In FIGS. 11 and 12, like elements may have like reference numbers to previously described embodiments, and the above descriptions may thus apply and repeated descriptions thereof may not be included. The shell 10′″ may be used with the strap 30 as described above, or may be used with the strap 30′, described in more detail below. In one or more embodiments, the shell 10′″ may be used with both the strap 30′ and the strap 30 concurrently or alternately.

The loops 33 may be attached to sides of the loop portion 13 so as not to interfere with the use of the strap 30, which may be used instead of or in addition to strap 30′, to be described in further detail below. The loops 33 may be placed on both left and right sides of the loop portions 13 in order to be accessible for use with strap 30′ without interfering with the attachment of the strap 30, if desired. The loops 33 may have a height substantially equal to the width of the strap 30′ and may be sufficiently wide along a width direction of the shell 10′″ to securely connect to the strap 30′ during use (e.g., while the animal wearing the footwear system is standing, walking, running, etc.). For example, the width of the loops 33 may be sufficiently wide to allow a hook 35 of the strap 30′ to be inserted, thus allowing the shell 10″ to be releasably connectable to and detachable from the strap 30′.

In the embodiments of FIGS. 11 and 12, the loops 33 are approximately half the height H1 of the loop portion 13, allowing two loops to be vertically arranged on each of the right and left sides of the loop portions 13. However, the present disclosure is not limited thereto. In some embodiments, the loops 33 may have a height approximately one third the height H1 of the loop portions 13, allowing a third loop to be vertically aligned along each of the left and right sides of the loop portions 13, for a total of six loops. In some embodiments, one, two, three or four loops may be included on each side of the loop portions 13, for a total of two, four, six or eight loops on each loop portion 13. In one or more embodiments, the loop portions 13 may each have a height H1 of about 0.5″ to about 3″ and the loops 33 may each have a height of about 0.25″ to about 1″.

Any of the loops 33 may be used with the strap 30′ to secure the shell 10′″ and/or sock 20 to the animal's paw, and a particular loop 33 may be selected, for example, based on the shape and/or size of the animal's paw and/or ankle to help secure the shell 10 and/or sock 20 at the animal's ankle. For example, the top loop 33 on the right side of the loop portion 13 and the bottom loop 33 on the left side of the loop portion 13 may be used, or any combination of a loop 33 on the right side and a loop 33 on the left side of the loop portion 13 may be used with the strap 30′. Thus, the inclusion of multiple loops 33 allows the shell 10 and/or sock 20 to be adjustable based on, for example, the physical characteristics of the animal's paw and/or ankle. The loops 33 may be included on only one surface (e.g., the front surface 14) or both surfaces (e.g., the front and back surfaces 14, 15) of the shell 10.

The loops 33 may be affixed to the shell 10′″, for example, the loops 33 may be sewn onto the shell 10′″. In one or more embodiments, the edges of the loops 33 may be placed under the loop portion 13 and then sewn onto the shell 10′″ with the loop portions 13, thus concealing the edges of the loops 33. The loops 33 may be made of or include a flexible or elastic fabric or material, such as elastane, spandex and/or lycra. However, the present disclosure is not limited thereto and the loops 33 may be made of any suitable fabric and/or material, whether elastic or not.

The loops 33 may be releasably connectable with the strap 30′. The strap 30′ may include a strip of material 34 (hereinafter referred to as the strip 34) and a slide 36 on the strip 34 to allow the strap 30′ to be adjustable to different lengths. Both ends of the strap 30′ may have a hook 35 to releasably attach to any of the loops 33 on the shell 10′″. The strap 30′ may be releasably attached to the loops 33 at the loop portion 13 of the front surface 14 or to the loops 33 at the loop portion 13 of the back surface 15. The strap 30′ may be wrapped around the animal's ankle one or more times and then attached to loops 33 on either the front surface 14 or the back surface 15.

The strip 34 may be made of a flexible, stretchy and/or elastic material, such as elastane, spandex and/or lycra. However, the present disclosure is not limited thereto and the strip 34 may be made of any suitable fabric and/or material, whether elastic or not. For example, the strip 34 may be made of a non-elastic material. In one or more embodiments in which a non-elastic material is used for the strip 34, two straps 30′ may be used, one or each of the left and right sides of the animal's ankle and each attached to loops 33 on the front surface 14 and attached to loops 33 on the back surface 15 via the hooks 35. The hook 35 and the slide 36 may be made of a rigid material, such as a hard plastic or metal, for example, a metal coated with a waterproof or water-resistant layer. Strap 30′ may offer a wider array of materials and patterns for more versatility. Strap 30′ may be good for individuals and/or animals that do not like hook and loop closures.

Strap 30′ may be used as a second strap (when there is already a strap 30 in place) to avoid complicated interactions. For example, a second strap 30 may attach to the hook and loop portions of the first strap 30 as it is being attached, making it difficult to position the second strap 30 as desired. The strap 30 may provide a solid structure to support the strap 30′ placed on top as a second strap, which can then be tightly wrapped on top of the strap 30 and worn for longer periods of time without cutting off circulation.

While the loops 33 are shown here as attached to the loop portions 13 of the shell 10′″ for ease of description, the loops 33 may be attached to the loop portions 23 of the front surface 24 and/or back surface 25 of the sock 20, 20′, 20″, in addition to or instead of the shell 10′″. The description of the loops 33 and strap 30′ above are applicable to such embodiments, with the loops 33 attached to the sides of the loop portion(s) 23 instead of the loop portion(s) 13, and thus a repeated description thereof may not be provided.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Unless otherwise noted, like reference numerals denote like elements throughout the attached drawings and the written description, and thus, duplicative descriptions thereof may not be provided.

It will be understood that, although the terms “first,” “second,” “third,” etc., may be used herein to describe various elements, such as components, areas, regions and/or portions, these elements should not be limited by these terms. These terms are used to distinguish one element from another element. Thus, a first element described below could be termed a second element without departing from the spirit and scope of the present disclosure.

It will be understood that when an element, such as a component, area, region, or portion, is referred to as being “on” or “connected to,” another element, it can be directly on or connected to the other element, or one or more intervening elements may be present. In addition, it will also be understood that when an element is referred to as being “between” two elements, it can be the only element between the two elements, or one or more intervening elements may also be present.

As used herein, the singular forms “a,” “an” and “the” are intended to include the plural forms as well, unless the context clearly indicates otherwise. It will be further understood that the terms “comprises,” “comprising,” “includes,” “including,” “have,” and “having,” when used in this specification, specify the presence of the stated features, steps, and/or elements, but do not preclude the presence or addition of one or more other features, steps, elements, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “Substantially” and “approximately,” as used herein, are inclusive of the stated value and means within an acceptable range of deviation for the particular value as determined by one of ordinary skill in the art, considering the measurement in question and the error associated with measurement of the particular quantity (i.e., the limitations of the measurement system) and/or variations in sewing/constructing the footwear system. For example, “substantially” or “approximately” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As used herein, the term “and/or” includes any and all combinations of one or more of the associated listed items.

Further, the use of “may” when describing embodiments of the present disclosure refers to “one or more embodiments of the present disclosure.”

As used herein, the terms “use,” “using,” and “used” may be considered synonymous with the terms “utilize,” “utilizing,” and “utilized,” respectively.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is an illustration of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A footwear system for an animal, the footwear system comprising:
a shell comprising a front surface and a back surface, each comprising a loop portion, and the shell having a top portion and a bottom portion, the top portion having a width smaller than a width of the bottom portion; and
a strap having a hook side comprising hooks, the hook side of the strap to be connected to the loop portions of the front and back surfaces of the shell,
wherein the front surface and the back surface comprise the same material.

2. The footwear system of claim 1, wherein the loop portion of the front surface and the loop portion of the back surface has a height greater than a width of the strap.

3. The footwear system of claim 1, wherein the top portion defines a top opening at a top of the top portion and a side opening at a side of the top portion, and the top and side openings are continuous with each other.

4. The footwear system of claim 1, wherein the shell further comprises loops attached to sides of the loop portion of the front surface and/or the loop portion of the back surface.

5. The footwear system of claim 1, wherein the top portion of the shell is open at at least one side.

6. The footwear system of claim 1, further comprising a sock to insert into the shell.

7. The footwear system of claim 6, wherein:
the sock comprises a front surface and a back surface, each comprising a loop portion,
the shell further comprises hook portions on inner surfaces of the shell, and
the loop portions of the sock are positioned to be connected to the hook portions of the shell when the sock is inserted into the shell.

8. The footwear system of claim 7, wherein the front surface of the sock and the back surface of the sock comprise the same material.

9. The footwear system of claim 7, wherein a height of each of the hook portions of the inner surfaces of the shell are about half a height of each of the loop portions of the front and back surfaces of the sock.

10. The footwear system of claim 6, wherein the sock is substantially the same height as the shell.

11. The footwear system of claim 6, wherein the sock has a height greater than a height of the shell.

12. The footwear system of claim 11, wherein the sock comprises a top portion having two edges along a width direction of the top portion, the top portion comprising a first loop portion near a first edge of the two edges and a second loop portion at a second edge of the two edges.

13. The footwear system of claim 12, further comprising a hook strip for releasably attaching to the first loop portion and the second loop portion.

14. The footwear system of claim 6, wherein the sock comprises tie ups to wrap around an animal's body.

15. The footwear system of claim 6, wherein the sock comprises a front surface and a back surface, wherein the front surface of the sock and the back surface of the sock comprise the same material.

16. The footwear system of claim 15, wherein the front surface and the back surface of the sock each include traction enhancers.

17. A footwear system for an animal, the footwear system comprising:
a shell comprising a front surface and a back surface, each comprising a loop portion, and the shell having a top portion and a bottom portion, the top portion having an intermediate waist smaller than a width of the bottom portion,
a sock to insert into the shell, and
a closure at the intermediate waist.

18. The footwear system of claim 17, wherein the closure is an elastic loop closure to wrap around the intermediate waist.

19. The footwear system of claim 17, wherein the closure comprises loops on the shell at different heights along a height of the shell and ties to thread through at least one of the loops to secure the shell to an animal's paw.

20. A footwear system for an animal, the footwear system comprising:
a shell having a top portion and a bottom portion, the top portion having a width smaller than a width of the bottom portion, the shell comprising:
a front surface comprising a loop portion;
a back surface comprising a loop portion; and
loops attached to sides of the loop portion of the front surface and/or to sides of the loop portion of the back surface; and
a strap comprising:
a strip having a slide on the strip to adjust a length of the strip; and
a hook attached to an end of the strip to releasably connect to any of the loops of the shell.
